(19) United States
(12) Patent Application Publication
(10) Pub. No.: US 2007/0034723 A1
(43) Pub. Date: Feb. 15, 2007

(54) Waste collection apparatus

(76) Inventors: David Joachim, Bridgewater, NJ (US); Timothy C. Repp, Pleasant Valley, CT (US)

Correspondence Address: Richard S. Roberts;Roberts & Roberts, L.L.P., Attorneys at Law, P.O. Box 484, Princeton, NJ, 08542-0484, US

(21) Appl. No.: 11/201,399

(22) Filed: Aug. 10, 2005

(51) Int. Cl. B02C 18/16

(52) U.S. Cl. 241/100

(57) ABSTRACT

A waste collection apparatus which includes multiple integrally attached waste collection receptacles. A first waste collection receptacle is intended for the collection of kitchen waste within a first refuse bin, and a second waste collection receptacle is intended for the shredding of paper and cardboard waste and the collection of the shredded waste within a second refuse bin. The inventive waste collection apparatus facilitates a separation of waste to be shredded and waste not to be shredded. The use of various features such as electrical switches and/or opposing lids may be employed to prevent the dropping or placing of undesired waste into the shredder.

### BACKGROUND OF THE INVENTION

1. Field of the Invention

The present invention relates to waste collection devices. More particularly, the invention relates to a waste collection apparatus which comprises multiple receptacles for shredding paper and collecting of different types of waste.

2. Description of the Related Art

Waste collection receptacles, such as trash containers, bins, cans, pails, and the like, are well known and are commercially available in a variety of sizes ranging from small waste basket sizes and 13 gallon kitchen containers, up to 33 gallon commercial containers and large bins such as dumpsters.

Waste shredders for the shredding materials such as paper, cardboard, floppy discs, and various other forms of waste are also well known in the art. See for example U.S. Pat. Nos. 5,014,920 and 5,400,978 which discloses electric, motorized shredder apparatuses for the shredding of waste, such as paper waste.

In recent years, consumer demand for shredder units has increased due to several factors. Increased awareness of environmental concerns has lead to the recycling of more paper waste. Furthermore, safety concerns regarding identity theft and other personal information theft has lead many consumers to shred their mail and other paper waste prior to disposal or recycling.

Since it is a common practice for many to open their mail and/or pay bills in the kitchen of their home, consumers often experience the need for a paper shredder in their kitchen, for the shredding of junk mail or other mail containing personal information. Unfortunately, the presence of a shredder in a kitchen, in addition to and often in close proximity to a food waste receptacle, is often undesirable either due to space constraints or aesthetics.

Thus it would be desirable to provide a combined shredder and waste collection receptacle. A potential problem exists, however, in that certain waste items are not intended to be shredded, and certain waste items, such as food waste would cause mechanical harm to the shredder itself. The present invention offers a solution to these problems.

The present invention provides a stand-alone waste collection apparatus which includes multiple, integrally attached waste collection receptacles. A first waste collection receptacle is intended for the collection of waste within a first refuse bin, and a second waste collection receptacle is intended for the shredding of thin waste such as paper and cardboard, and the collection of such shredded waste within a second refuse bin. The inventive waste collection apparatus facilitates a separation of waste to be shredded and waste not to be shredded. Furthermore, features such as electrical switches and/or opposing lids may be employed to prevent the dropping or placing of undesired waste into the shredder.

### SUMMARY OF THE INVENTION

The invention provides a waste collection apparatus which comprises:

a) a first waste collection receptacle comprising:
i) a first refuse bin for the collection of waste; said first refuse bin having an opening at a top thereof; and
ii) a refuse lid hingedly attached at the top of the first refuse bin, which refuse lid is capable of alternately covering and uncovering the opening at the top of the first refuse bin;

b) a second waste collection receptacle integrally attached to said first waste collection receptacle, which second waste collection receptacle comprises:
i) a second refuse bin, having a top opening, for the collection of shredded waste;
ii) a motorized shredder positioned at the top opening of the second refuse bin, said shredder having an upper insertion slot for the insertion of matter to be shredded and having a lower waste discharge end, said shredder being positioned to discharge shredded waste into the second refuse bin; and
iii) a shredder lid hingedly attached at the top of the shredder, which shredder lid is capable of alternately covering and uncovering the upper insertion slot of the shredder.

The invention also provides a waste collection apparatus which comprises:

a) a first waste collection receptacle comprising:
i) a first refuse bin for the collection of waste; said first refuse bin having an opening at a top thereof; and
ii) a refuse lid hingedly attached at the top of the first refuse bin, which refuse lid is capable of alternately covering and uncovering the opening at the top of the first refuse bin;

b) a second waste collection receptacle integrally attached to said first waste collection receptacle, which second waste collection receptacle comprises:
i) a support frame defining a central cavity and having a top opening,
ii) a motorized shredder having an upper insertion slot for the insertion of matter to be shredded and having a lower waste discharge end, said shredder being positioned at the top opening of the support frame such that the shredder is supported by the support frame and positioned above said central cavity;
iii) a removable second refuse bin positioned within said central cavity and below said shredder, which second refuse bin is capable of collecting shredded waste discharged from the shredder; and

iii) a shredder lid hingedly attached at a top of the shredder, which shredder lid is capable of alternately covering and uncovering the upper insertion slot of the shredder.

The invention further provides method for collecting waste which comprises:

I) providing a waste collection apparatus which comprises:
a) a first waste collection receptacle comprising:
   i) a first refuse bin for the collection of waste; said first refuse bin having an opening at a top thereof; and
   ii) a refuse lid hingedly attached at the top of the first refuse bin, which refuse lid is capable of alternately covering and uncovering the opening at the top of the first refuse bin;
b) a second waste collection receptacle integrally attached to said first waste collection
   receptacle, which second waste collection receptacle comprises:
   i) a second refuse bin, having a top opening, for the collection of shredded waste;
   ii) a motorized shredder positioned at the top opening of the second refuse bin, said shredder having an upper insertion slot for the insertion of matter to be shredded and having a lower waste discharge end, said shredder being positioned to discharge shredded waste into the second refuse bin; and
   iii) a shredder lid hingedly attached at the top of the shredder, which shredder lid is capable of alternately covering and uncovering the upper insertion slot of the shredder; and
c) a electrical switch capable of blocking electric power to the motorized shredder when the shredder lid covers the upper insertion slot of the shredder;

II) covering the upper insertion slot of the shredder with the shredder lid, thereby causing the electrical switch to block electric power to the motorized shredder; and

III) uncovering the opening at the top of the first refuse bin via the refuse lid, and placing waste into the refuse bin.

### BRIEF DESCRIPTION OF THE DRAWINGS

FIG. 1 shows a front side perspective view of a waste collection apparatus of the invention.

FIG. 2 shows a rear side perspective view of a waste collection apparatus of the invention with the shredder lid and refuse lid both in an open position.

FIG. 3 shows a top view of a waste collection apparatus of the invention.

FIG. 4 shows a side schematic view of a waste collection apparatus of the invention having a removable shredder bin.

FIG. 5 shows a rear schematic view of a waste collection apparatus of the invention, having a support frame for a removable shredder bin.

FIG. 6 shows a front side perspective view of a waste collection apparatus of the invention with the shredder lid and refuse lid both in an open position facing the same direction.

FIG. 7 shows a front side perspective view of a waste collection apparatus of the invention with the shredder lid and refuse lid both in an open position facing opposite directions.

### DETAILED DESCRIPTION OF THE INVENTION

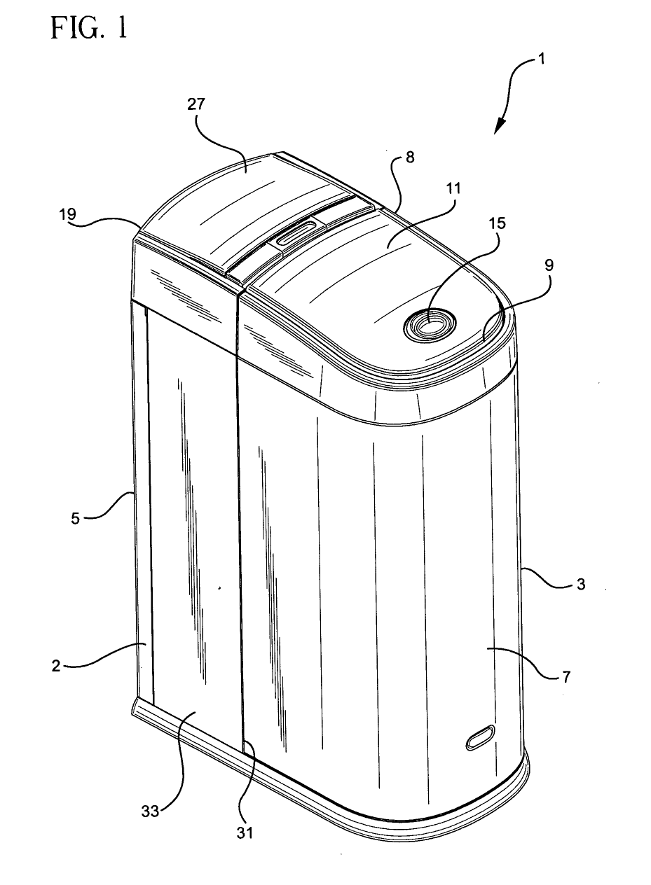

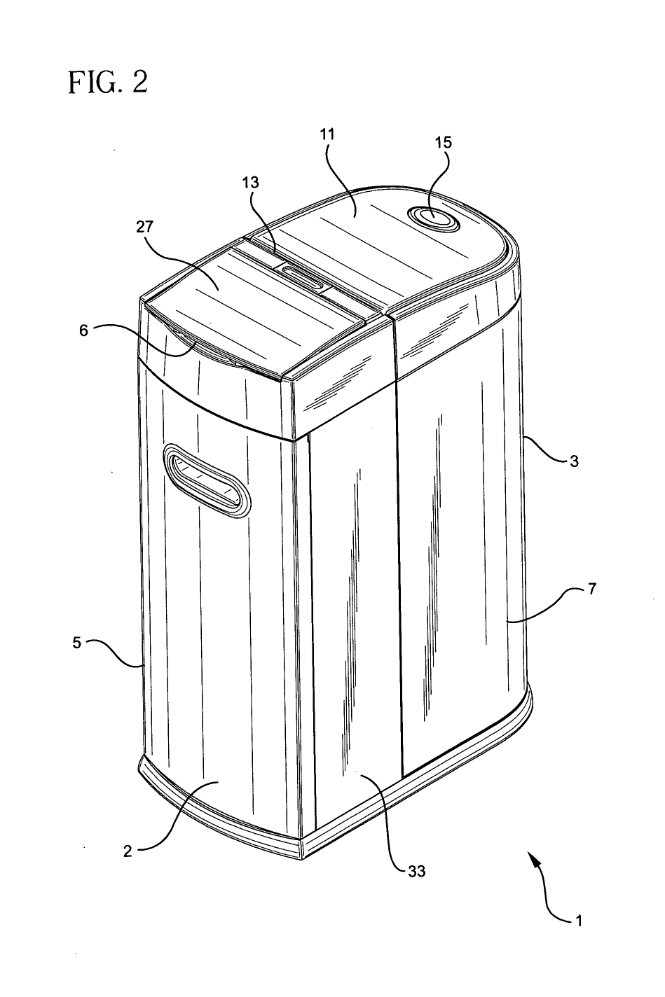

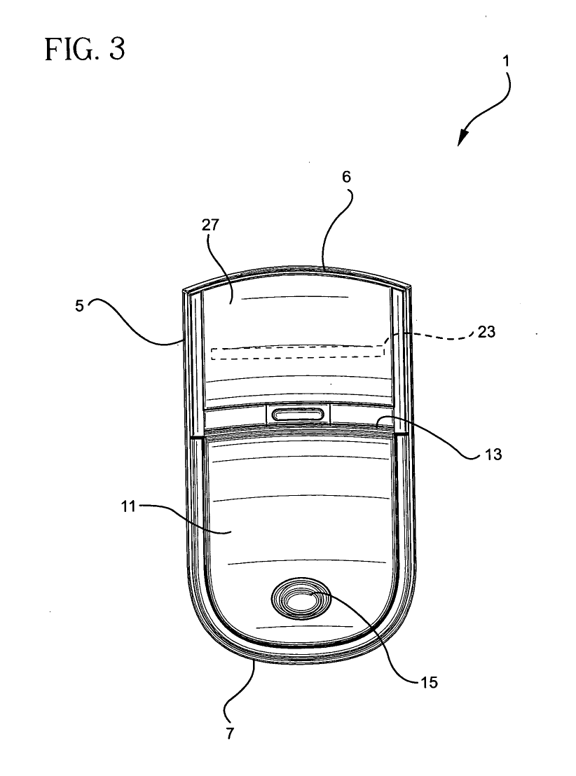

The invention provides a waste collection apparatus 1, which is shown in FIGS. 1-7. As the Figures show, a waste collection apparatus 1 is provided which includes a housing 8 comprising a first waste collection receptacle 3, and a second waste collection receptacle 5 integrally attached to the first waste collection receptacle 3 at a wall 31. The housing 8 serves as a protective structure for encasing other components of the apparatus. The housing may comprise plastic, metal, rubber, and the like or combinations thereof, or any other material which one skilled in the art may deem suitable for forming a protective structure. In one specific embodiment, portions of the housing comprise plastic, and portions of the housing comprise stainless steel or aluminum.

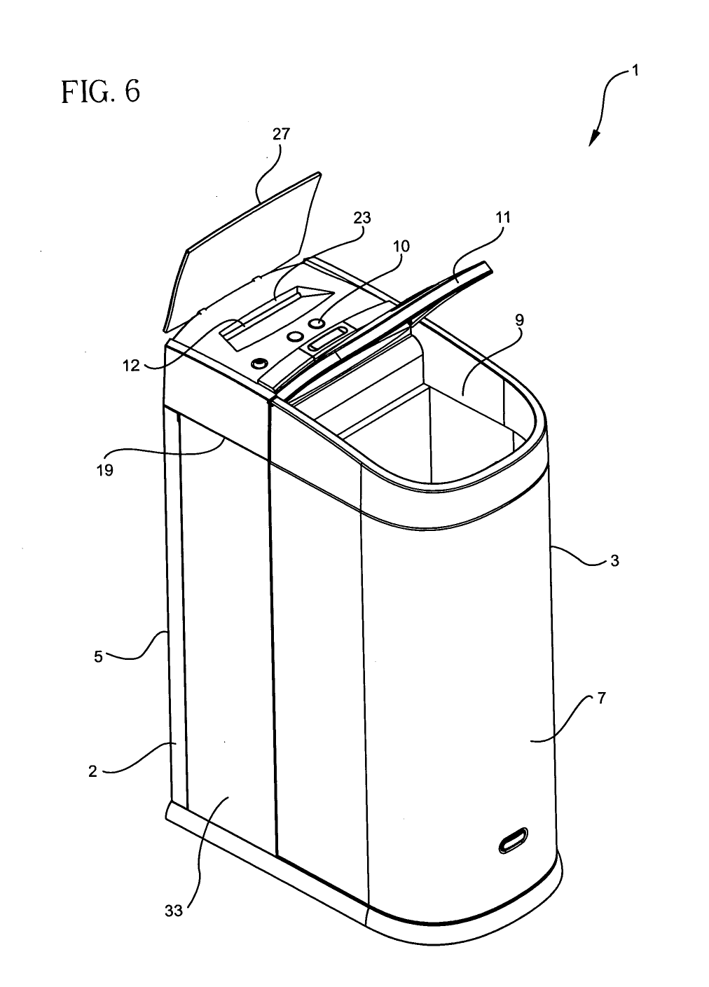

The first waste collection receptacle 3 comprises a first refuse bin 7, for the collection of general kitchen waste. The first refuse bin 7 comprises a container having an opening 9 at a top thereof as best seen in FIG. 6. The first refuse bin 7 further comprises a refuse lid 11 which is hingedly attached at the top of the first refuse bin 7. The refuse lid 11 is capable of alternately covering and uncovering the opening 9 at the top of the first refuse bin 7. In a specific embodiment the refuse lid 11 is hingedly attached at the top of the first refuse bin 7 via a spring and hinge arrangement 13. The refuse lid 1 1 may further comprise an internal push latch 4 capable of alternately securing the refuse lid 11 to, and releasing the refuse lid 11 from, the top of the first refuse bin 7. The first refuse bin 7 may also further comprise a removable internal drip tray 17 positioned at a bottom of the first refuse bin 7. Such a drip tray 17 is particularly useful when collecting food waste such as kitchen waste in the first refuse bin 7. The drip tray 17 may be accessible from the inside or the outside of the first refuse bin 7. In one embodiment, the drip tray is accessible via a removable drawer at a bottom of the first refuse bin.

As shown in FIGS. 1, 2, and 4, the second waste collection receptacle 5 is integrally attached to the first waste collection receptacle 3 at wall 31. The second waste collection receptacle 5 preferably serves to collect shredded waste such as shredded paper.

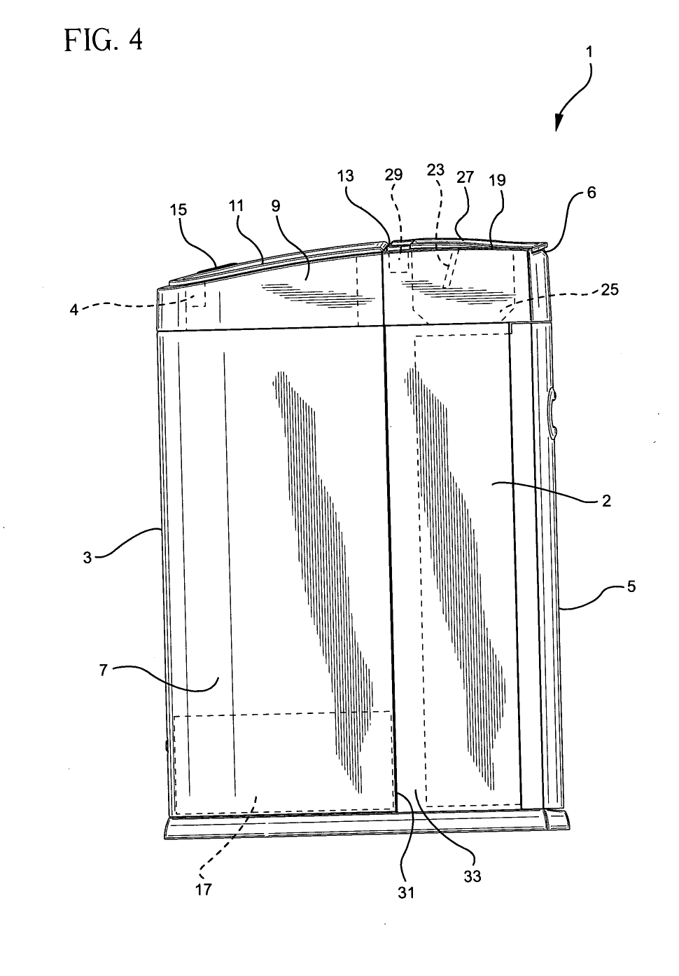

The second waste collection receptacle 5 may comprise a second refuse bin 2 comprising a container having an opening 19 at a top thereof. As shown in FIG. 4, a motorized shredder 21 is positioned at the top opening 19 of the second refuse bin 2.

The shredder 21 has a linear upper insertion slot 23 for the insertion into the shredder of matter to be shredded. Optionally but preferably, the shredder 21 further includes a safety bar 12 across the upper insertion slot 23.

The shredder 21 further has a lower waste discharge end 25 for the discharge of shredded waste from the shredder 21. Motorized shredders such as paper shredders are well known in the art. The shredder 21 is electrically connected to a power source. The power source may comprise any conventional power supplying means known in the art such as batteries, AC power, or the like.

The shredder 21 is preferably positioned such that a matter to be shredded is inserted into the upper insertion slot 23, shredded by the motorized shredder 21, and the resulting shredded waste is thereby discharged from the lower waste discharge end 25 into the second refuse bin 2. The second refuse bin 2 is preferably removable from the waste collection apparatus 1. In a specific embodiment, the second refuse bin 2 is capable of being removed from the second waste collection receptacle 5 without removing the shredder 21 from its position at the top opening 19 of the second refuse bin 2. This is particularly useful when collecting shredded paper waste within the second refuse bin 2.

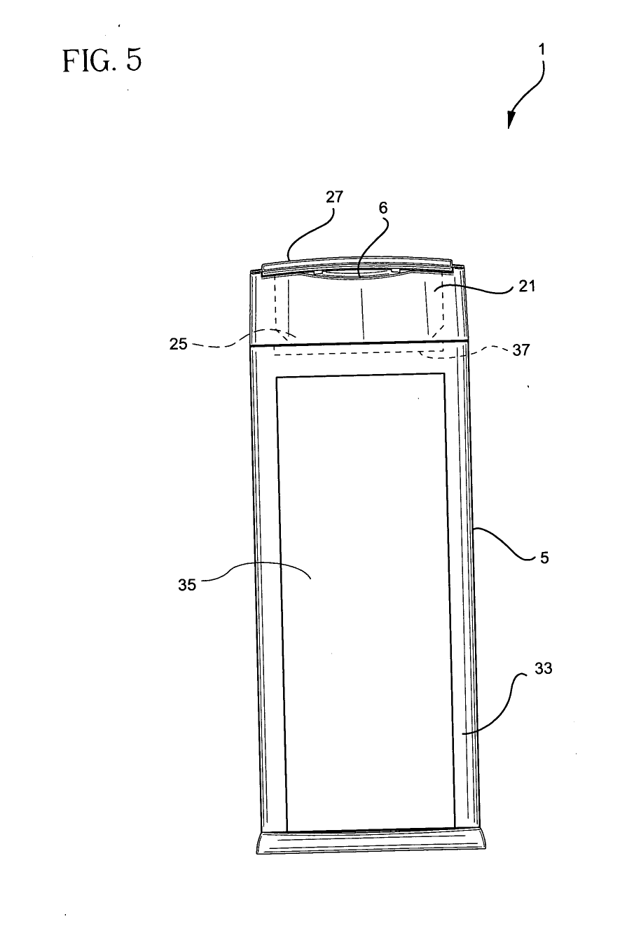

In one embodiment, shown in FIG. 5, the second waste collection receptacle 5 comprises a support frame 33 defining a central cavity 35 and having a top opening 37. A motorized shredder 21, as described above, is positioned at the top opening 37 of the support frame 33 such that the shredder 21 is supported by the support frame 33 and positioned above said central cavity 35. A removable second refuse bin 2 is to be positioned within said central cavity 35 and below said shredder 21, such that the second refuse bin 2 is capable of collecting shredded waste discharged from the shredder 21.

The motorized shredder 21 of the invention preferably comprises a shredder lid 27 which is hingedly attached at a top of the shredder 21. The shredder lid 27 is preferably capable of alternately covering and uncovering the upper insertion slot 23 of the shredder 21. In one embodiment the shredder lid 27 is hingedly attached at the top of the shredder 21 via a spring and hinge arrangement 6. The shredder lid 27 may further comprise a push latch 29 capable of alternately securing the shredder lid 27 to, and releasing the shredder lid 27 from, the top of the shredder 21.

The waste collection apparatus 1 preferably comprises an electrical switch capable of blocking electric power to the motorized shredder 21 when the shredder lid 27 is positioned to cover the upper insertion slot 23 of the shredder 21. While the electric power to the shredder 21 is blocked, a user may uncover the opening 9 at the top of the first refuse bin 7 via the refuse lid 11 and place waste into the first refuse bin 7 without mistakenly placing or dropping waste into the shredder 21.

In an alternate embodiment, the waste collection apparatus 1 comprises an electrical switch capable of blocking electric power to the motorized shredder 21 when the refuse lid 11 is open, that is when the refuse bin 11 is positioned to uncover the opening 9 at the top of the first refuse bin 7. In a further alternate embodiment, the refuse lid 11 comprises an electric switch capable of locking the refuse lid 11, thereby hindering the uncovering of the opening 9 at the top of the first refuse bin 7 while the shredder 21 is in operation. In a further alternate embodiment, the shredder lid 27 comprises an electrical switch capable of locking the shredder lid 27, thereby hindering the uncovering of upper insertion slot 23 of the shredder 21 while the first refuse bin 7 is uncovered.

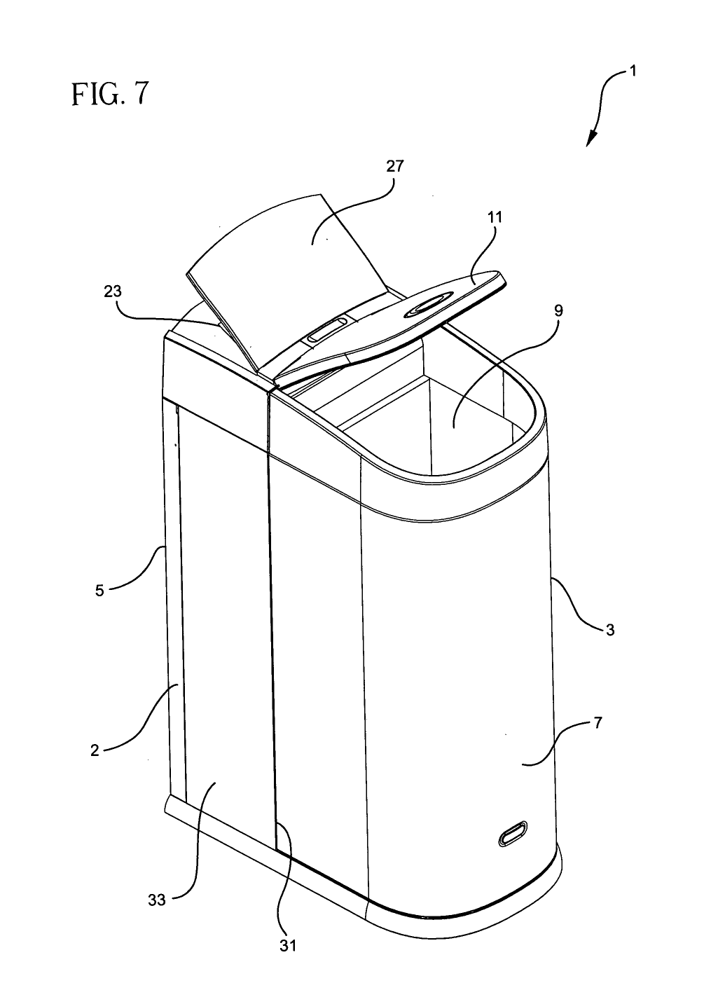

In one embodiment, as shown in FIG. 7, the refuse lid 11 and the shredder lid 27 are arranged to open in opposed positions relative to one another. Optionally, the opposed lids are arranged such that an uncovering of the opening 9 at the top of the first refuse bin 7 via the refuse lid 11 hinders the uncovering of the upper insertion slot 23 of the shredder 21 by the shredder lid 27 and an uncovering of the upper insertion slot 23 of the shredder 21 via the shredder lid 27 hinders the uncovering of the top of the first refuse bin 7 by the refuse lid 11.

In one embodiment, shown in FIG. 6, the refuse lid 11 and the shredder lid 27 are arranged such that when the refuse lid 11 is positioned to uncover the opening 9 at the top of the first refuse bin 7, and the shredder lid 27 is positioned to uncover the upper insertion slot 23 of the shredder 21, both the refuse lid 11 and the shredder lid 27 are independently openable in the same direction. That is, both the shredder lid 27 and the refuse lid 11 are accessible from the same direction.

In still another embodiment, as not shown in the drawings, the refuse lid 11 and the shredder lid 27 are arranged such that when the refuse lid 11 is positioned to uncover the opening 9 at the top of the first refuse bin 7, and the shredder lid 27 is positioned to uncover the upper insertion slot 23 of the shredder 21, the refuse lid 11 and the shredder lid 27 open toward each other.

Preferably the first waste collection receptacle 3 and the second waste collection receptacle 5 are integrally attached at a common wall 31. In one embodiment the common wall 31 comprises a transparent viewing window. This transparent viewing window may comprise any suitable material which would enable a viewer to see through said viewing window, nonexclusively including glass, plexiglass, mesh materials, and the like.

The waste collection apparatus 1 of the invention may further comprise various control buttons 10, for controlling features of the invention such as shredder power, shredder speed, forward and reverse shredder direction movement, and/or locking of the shredder lid and/or refuse lid, and the like. In addition the inventive waste collection apparatus may further comprise a display such as an LCD screen, a shredder on/off indicator, a clock, and the like.

The present invention serves to provide a waste collection apparatus 1 that was heretofore absent from the electronics market. Not only does it provide a stand-alone combination waste collection unit which is integrally attached to a separate shredder unit, but it also provides a way to ensure that undesirable waste, which is intended for the refuse bin 7, is not mistakenly dropped or placed into the shredder 21.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A waste collection apparatus which comprises:
a) a first waste collection receptacle comprising:
i) a first refuse bin for the collection of waste; said first refuse bin having an opening at a top thereof; and
ii) a refuse lid hingedly attached at the top of the first refuse bin, which refuse lid is capable of alternately covering and uncovering the opening at the top of the first refuse bin;
b) a second waste collection receptacle integrally attached to said first waste collection receptacle, which second waste collection receptacle comprises:
i) a second refuse bin, having a top opening, for the collection of shredded waste;
ii) a motorized shredder positioned at the top opening of the second refuse bin, said shredder having an upper insertion slot for the insertion of matter to be shredded and having a lower waste discharge end, said shredder being positioned to discharge shredded waste into the second refuse bin; and
iii) a shredder lid hingedly attached at the top of the shredder, which shredder lid is capable of alternately covering and uncovering the upper insertion slot of the shredder.

2. The waste collection apparatus of claim 1 wherein the first waste collection receptacle and the second waste collection receptacle are integrally attached at a common wall.

3. The waste collection apparatus of claim 2 wherein the common wall comprises a transparent viewing window.

4. The waste collection apparatus of claim 1 which further comprises an electrical switch capable of blocking electric power to the motorized shredder when the shredder lid covers the upper insertion slot of the shredder.

5. The waste collection apparatus of claim 1 wherein the refuse lid and the shredder lid are arranged in opposed positions relative to one another such that an uncovering of the opening at the top of the first refuse bin via the refuse lid hinders the uncovering of the upper insertion slot of the shredder by the shredder lid, and such that an uncovering of the upper insertion slot of the shredder via the shredder lid hinders the uncovering of the top of the first refuse bin by the refuse lid.

6. The waste collection apparatus of claim 1 wherein the refuse lid and the shredder lid are arranged such that both the refuse lid and the shredder lid are openable toward the same direction.

7. The waste collection apparatus of claim 1 wherein the refuse lid is hingedly attached to the refuse bin via a spring and hinge arrangement, and/or the shredder lid is hingedly attached to the shredder bin via a spring and hinge arrangement.

8. The waste collection apparatus of claim 1 wherein the refuse lid comprises a push latch capable of alternately securing the refuse lid to, and releasing the refuse lid from, the top of the first refuse bin.

9. The waste collection apparatus of claim 1 wherein the shredder lid comprises a push latch capable of alternately securing the shredder lid to, and releasing the shredder lid from, the top of the shredder.

10. The waste collection apparatus of claim 1 wherein said first refuse bin comprises a removable internal drip tray at a bottom of the refuse bin.

11. The waste collection apparatus of claim 1 wherein said second refuse bin is removable from the waste collection apparatus.

12. The waste collection apparatus of claim 1 which further comprises a safety bar across the upper insertion slot of the shredder.

13. A waste collection apparatus which comprises:
a) a first waste collection receptacle comprising:
i) a first refuse bin for the collection of waste; said first refuse bin having an opening at a top thereof; and
ii) a refuse lid hingedly attached at the top of the first refuse bin, which refuse lid is capable of alternately covering and uncovering the opening at the top of the first refuse bin;
b) a second waste collection receptacle integrally attached to said first waste collection receptacle, which second waste collection receptacle comprises:
i) a support frame defining a central cavity and having a top opening,
ii) a motorized shredder having an upper insertion slot for the insertion of matter to be shredded and having a lower waste discharge end, said shredder being positioned at the top opening of the support frame such that the shredder is supported by the support frame and positioned above said central cavity;
iii) a removable second refuse bin positioned within said central cavity and below said shredder, which second refuse bin is capable of collecting shredded waste discharged from the shredder; and
iii) a shredder lid hingedly attached at a top of the shredder, which shredder lid is capable of alternately covering and uncovering the upper insertion slot of the shredder.

14. The waste collection apparatus of claim 13 wherein the first waste collection receptacle and the second waste collection receptacle are integrally attached at a common wall.

15. The waste collection apparatus of claim 13 wherein the common wall comprises a transparent viewing window.

16. The waste collection apparatus of claim 13 which further comprises an electrical switch capable of blocking electric power to the motorized shredder when the shredder lid covers the upper insertion slot of the shredder.

17. The waste collection apparatus of claim 13 wherein the refuse lid and the shredder lid are arranged in opposed positions relative to one another such that an uncovering of the opening at the top of the first refuse bin via the refuse lid hinders the uncovering of the upper insertion slot of the shredder by the shredder lid, and such that an uncovering of the upper insertion slot of the shredder via the shredder lid hinders the uncovering of the top of the first refuse bin by the refuse lid.

18. The waste collection apparatus of claim 13 wherein the refuse lid and the shredder lid are arranged such that when the refuse lid is positioned to uncover the opening at the top of the first refuse bin, and the shredder lid is positioned to uncover the upper insertion slot of the shredder, both the refuse lid and the shredder lid open toward the same direction.

19. The waste collection apparatus of claim 13 wherein the refuse lid is hingedly attached to the refuse bin via a spring and hinge arrangement, and/or the shredder lid is hingedly attached to the shredder bin via a spring and hinge arrangement.

20. The waste collection apparatus of claim 13 wherein the refuse lid comprises a push latch capable of alternately securing the refuse lid to, and releasing the refuse lid from, the top of the first refuse bin.

21. The waste collection apparatus of claim 13 wherein the shredder lid comprises a push latch capable of alternately securing the shredder lid to, and releasing the shredder lid from, the top of the shredder.

22. The waste collection apparatus of claim 13 wherein said first refuse bin comprises a removable internal drip tray at a bottom of the refuse bin.

23. The waste collection apparatus of claim 13 wherein said second refuse bin is removable from the waste collection apparatus.

24. A method for collecting waste which comprises:
I) providing a waste collection apparatus which comprises:
a) a first waste collection receptacle comprising:
i) a first refuse bin for the collection of waste; said first refuse bin having an opening at a top thereof; and
ii) a refuse lid hingedly attached at the top of the first refuse bin, which refuse lid is capable of alternately covering and uncovering the opening at the top of the first refuse bin;
b) a second waste collection receptacle integrally attached to said first waste collection
receptacle, which second waste collection receptacle comprises:
i) a second refuse bin, having a top opening, for the collection of shredded waste;
ii) a motorized shredder positioned at the top opening of the second refuse bin, said shredder having an upper insertion slot for the insertion of matter to be shredded and having a lower waste discharge end, said shredder being positioned to discharge shredded waste into the second refuse bin; and
iii) a shredder lid hingedly attached at the top of the shredder, which shredder lid is capable of alternately covering and uncovering the upper insertion slot of the shredder; and
c) an electrical switch capable of blocking electric power to the motorized shredder when the shredder lid covers the upper insertion slot of the shredder;
II) covering the upper insertion slot of the shredder with the shredder lid, thereby causing the electrical switch to block electric power to the motorized shredder; and
III) uncovering the opening at the top of the first refuse bin via the refuse lid, and placing waste into the refuse bin.
